(19) United States
(12) Patent Application Publication
(10) Pub. No.: US 2024/0242484 A1
(43) Pub. Date: Jul. 18, 2024

(54) SYSTEM AND METHOD FOR ROBUST TRACKING OF INDUSTRIAL OBJECTS ACROSS ENVIRONMENTS FROM SMALL SAMPLES IN SINGLE ENVIRONMENTS USING CHROMA-KEY AND OCCLUSION AUGMENTATIONS

(71) Applicant: Palo Alto Research Center Incorporated, Palo Alto, CA (US)

(72) Inventors: Robert Roy Price, Palo Alto, CA (US); Yan-Ming Chiou, Milpitas, CA (US)

(73) Assignee: Palo Alto Research Center Incorporated, Palo Alto, CA (US)

(21) Appl. No.: 18/098,009

(22) Filed: Jan. 17, 2023

(51) Int. Cl. G06V 10/774; G06T 7/215; G06V 10/26; G06V 10/56; G06V 10/77

(52) U.S. Cl. CPC G06V 10/774; G06T 7/215; G06V 10/273; G06V 10/56; G06V 10/7715; G06T 2207/20081

(57) ABSTRACT

An augmented data set is generated by combining chroma key substitutions for background and occlusion augmentations for foreground to enable training of object detectors or action recognition that transfers to multiple environments and is robust to occlusion due to other objects or human hands.

### BACKGROUND

Detection and tracking of objects are key to many applications such as security, robotics, and industrial process monitoring. In recent years, large pretrained foundation models have shown good performance when fine-tuned on detection and tracking tasks. However, these pretrained models are typically trained on common classes of everyday objects such as dogs, or cars, and may not generalize to industrial parts. Also, the pretrained models can be very large, making them difficult to use in embedded systems found in consumer electronics, process monitoring and robotics. Smaller models can be used when trained with sufficient data but it can be difficult to acquire enough training data for specialized industrial components to produce robust detectors and trackers across a variety of backgrounds.

Thus, the current state of the art lacks methods for building robust detectors from a small number of samples captured in a limited number of settings. As a specific example, training deep models that can be deployed on embedded systems to robustly detect and track highly specialized industrial objects in a variety of field environments remains very challenging.

Moreover, augmentation is a long-standing technique for improving computer vision models. There are many popular packages implementing standard transforms such as rotation, flipping horizontally or vertically, adding noise of various kinds, changing brightness and contrast, hue shift, gamma transforms, etc. Popular libraries include scikit-image transforms, pytorch vision and Albumentations.

In this regard, recent creative augmentations have been proposed which put together copies of images to generate new images with novel class combinations, crops, rotations and variance in number. Other augmentations consisting of random boxes drawn over the image have also been introduced. In another augmentation, objects from different classes are blended over each other to create soft classification problems reducing overfitting objects (e.g., MOSAIC, MIXUP).

### BRIEF DESCRIPTION

According to one aspect of the presently described embodiments, a system for creating data sets for robust object and action detectors from a small number of images gathered in one environment comprises at least one processor, and, at least one memory having stored therein instructions, the memory and instructions being configured such that execution of the instructions by the processor causes the system to capture an image having at least one object therein, wherein the image has a background with at least one identifiable property, augment the image by background substitution, apply a bounding box around the object, and, introduce random foreground occlusions to the object, whereby augmented image data is obtained.

According to another aspect of the presently described embodiments, the background substitution comprises continuous alpha blending between the image and the substitution based on an angular distance in hue space between the pixels in the background of the target image and the reference chroma value.

According to another aspect of the presently described embodiments, the background substitution comprises random noise at multiple scales.

According to another aspect of the presently described embodiments, the background substitution comprises natural images cropped, translated and resampled at multiple scales.

According to another aspect of the presently described embodiments, the foreground occlusions comprise curtain occlusions that partially obscure left, right, top or bottom of objects to random degrees.

According to another aspect of the presently described embodiments, the foreground occlusions comprise rectangles of various sizes sampled within a ground truth bounding box of the object.

According to another aspect of the presently described embodiments, the foreground occlusions comprise a grid of objects including at least one of circles, squares or lines.

According to another aspect of the presently described embodiments, the system memory and instructions are further configured such that execution of the instructions by the processor causes the system to train a detecting or tracking system based on the augmented image data.

According to one aspect of the presently described embodiments, a method for creating robust object and action detectors from a small number of images gathered in one environment, comprises capturing an image having at least one object therein, wherein the image has a background, augmenting the image by background substitution, applying a bounding box around the object, and, introducing random foreground occlusions to the object, whereby augmented image data is obtained.

According to one aspect of the presently described embodiments, the background substitution comprises continuous alpha blending between the image and the substitution based on an angular distance in hue space between the pixels in the background of the target image and the reference chroma value.

According to one aspect of the presently described embodiments, the background substitution comprises random noise at multiple scales.

According to one aspect of the presently described embodiments, the background substitution comprises natural images cropped, translated, and resampled at multiple scales.

According to one aspect of the presently described embodiments, the foreground occlusions comprise curtain occlusions that partially obscure left, right, top or bottom of objects.

According to one aspect of the presently described embodiments, the foreground occlusions comprise rectangles sampled within the bounding boxes of objects in ground truth labels.

According to one aspect of the presently described embodiments, the foreground occlusions comprise a grid of objects including at least one of circles, squares, or lines.

According to one aspect of the presently described embodiments, the method further comprises training a detecting or tracking system based on the augmented image data.

According to one aspect of the presently described embodiments, a system for robust object and action detectors from a small number of images gathered in one environment, comprises at least one processor, and, at least one memory having stored therein instructions, the memory and instructions being configured such that execution of the instructions by the processor causes the system capture the environment and detect objects in the environment using a model trained on data augmented by background substitution and foreground occlusions.

According to one aspect of the presently described embodiments, a method for robust object and action detectors from a small number of images gathered in one environment comprises capturing the environment and detecting objects in the environment using a model trained on data augmented by background substitution and foreground occlusions.

According to one aspect of the presently described embodiments, a non-transitory computer readable medium has instructions stored thereon that, when executed, cause an apparatus to perform loading an image having at least one object therein, wherein the image has a background, augmenting the image by background substitution, applying a bounding box around the object, and, introducing random foreground occlusions to the object, whereby augmented image training data is obtained, possibly multiple times to augment the same image multiple times.

According to one aspect of the presently described embodiments, a non-transitory computer readable medium has instructions stored thereon that, when executed, cause an apparatus to perform capturing an environment and detecting objects in the environment using a model trained on data augmented by background substitution and foreground occlusions.

### BRIEF DESCRIPTION OF THE DRAWINGS

FIG. 1 is an illustration of an image;

FIG. 2(a) is a flowchart of an example method according to the presently described embodiment;

FIG. 2(b) is a flowchart of an example method according to the presently described embodiment; and

FIG. 3 is an example system into which the presently described embodiments may be implemented.

### DETAILED DESCRIPTION

The presently described embodiments relate to the creation of robust object classifiers and action recognition systems in small light weight networks. In at least one form, a novel data augmentation strategy is implemented that provides superior generalization from lab collected images to a variety of field settings including scenarios where objects are occluded by other objects or people manipulating them. That is, the presently described embodiments relate to an augmentation pipeline that allows for the capture of images of industrial components during a single lab situation and artificially augments these images in a way that generates a robust highly generalizable detector that can be deployed in the field in many different scenarios. Such a detector may be implemented in a variety of forms and environments, such as devices that facilitate task assistance. Examples, without limitation, include tablets, augmented reality devices, head or chest mounted interactive devices, cameras, webcams, mobile phones or other devices or systems or networks.

The presently described embodiments use chroma-key like substitutions combined with artificial occlusion generation to allow for the capture of objects under a fixed background in the lab and then generalize them to novel backgrounds that work in the real world under realistic conditions. More specifically, the presently described embodiments combine chroma key substitutions for background with novel occlusion augmentations for foreground to enable training of object detectors or action recognition that transfers well to multiple environments and is robust to occlusion due to other objects or human hands. In at least one form, these techniques handle this case significantly better than state of the art methods—obtaining substantial improvements over standard techniques.

It should be appreciated that, in at least one form, the presently described embodiments include a training aspect, wherein a data set of images of objects is generated and used to train a detection and tracking system, and an implementation aspect, wherein the system for detecting and tracking is used by individuals to robustly detect and track, for example, highly specialized industrial objects for a variety of different field environments where comprehensive accurately labeled data sets are traditionally unavailable.

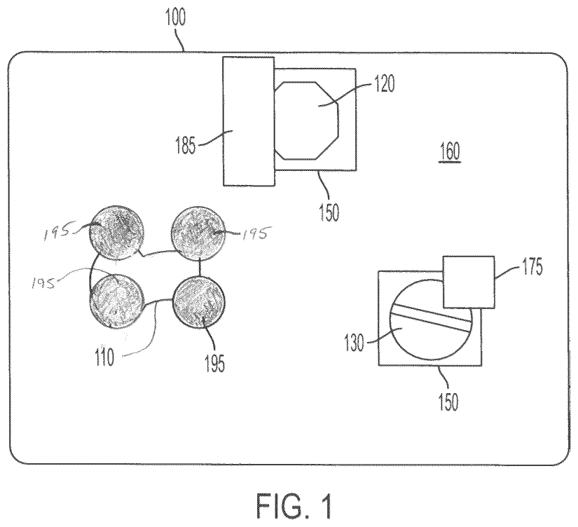

With reference now to FIG. 1, an environment for generating a data set, to be later used to train a detecting or tracking system, is illustrated. As shown, an image 100 of a variety of different objects is captured. For simplicity of explanation, a knob 110, a hex bolt 120 and a screw head 130 are shown in a single image—although the image may include only one object or more objects, depending on the implementation. A background 160 of the image is shown and, in at least one form would have at least one identifiable property such as, for example, a color comprising approximately a single color (i.e., a single color background is chosen, but due to lighting, shadows, reflections and viewing angle the exact hue and value may vary somewhat across the image). The chosen background color may vary; however, for chromakey-type applications, the color of the background is typically green (although it is not shown as green in the line drawing of FIG. 1). Also shown for illustrative purposes, as will be explained in further detail below, are bounding boxes 150 applied to the hex bolt 120 and screw head 130. Likewise shown for illustrative purposes are rectangular occlusion of an object 175, curtain occlusion of an object 185 and circular occlusion of an object 195.

According to the presently described embodiments, with continuing reference to FIG. 1, a data set for training is, in at least form, generated by using the chroma key augmentations to provide the ability to recognize objects, such as objects 110, 120 and 130, in a variety of different contexts that are not seen in the training data. The substitution of the background 160 with a variety of backgrounds, replacing background 160, effectively decouples the foreground characteristics of the object from the background context making adversarial attacks more difficult as well. Backgrounds that are used for substitution may take a variety of forms but, in at least some forms, include random noise at various scales and natural images at various scales.

In at least one form, the background substitution method converts images to HSV space, as is often done in chroma-key based separation. Then, the hue component is converted to an angle and angles between a target hue value and the pixels of an image are computed. A continuous blending is then accomplished. This gives a smoother substitution with less artifacts and works for any hue, including hues near the edge of the HSV color space (e.g., red), allowing for easy adaption of the chroma key color to any convenient part of the spectrum.

According to the presently described embodiments, in at least one form, the background replacement may be implemented by using many different types of substitutions to maximize generalization. For example, a black and a white background may be used to replace pixels with minimum energy and maximum energy scenes to improve robustness to extreme cases. As a further example, random pixel noise at multiple scales may be incorporated in the background to eliminate classifier dependence on background features. As a still further example, natural backgrounds may be introduced at multiple scales to ensure the network classifies objects with intermediate levels of scene energy expected in the target fields.

As noted, the background substitution, in at least one form of the presently described embodiments, is combined with several unique foreground substitutions. According to the presently described embodiments, in at least one form, occlusion augmentations are implemented by generating masks that are a fraction of bounding boxes. This has the impact of emphasizing, for training purposes, various parts and aspects of the objects, as opposed to, for example, only the object as a whole. It also allows the trained network to recognize the object from a partial view instead of requiring the whole object. Thus, a variety of colors, textures and/or forms are used instead of just black.

In this regard, according to the presently described embodiments, in at least one form, a new form of occlusion called a curtain occlusion, as referenced herein, such as curtain occlusion 185, black out part of a ground truth bounding box, such as bounding box 150, around the hex bolt 120, from one side, which helps with frame occlusions. The “curtain” augmentation may be implemented in a variety of manners, however, in at least one form, it is used in implementations in which ground truth bounding boxes in the training data are used to localize a region of the image. As applied in one example, part of the image is randomly occluded from either the left edge of the bounding box or the right edge up to a random point less than a maximum threshold. This is similar to pulling a curtain across the box. As but one advantage of this type of occlusion, it helps the detection and/or tracking system or network deal with object-object and object-image frame occlusions better in the real world.

A further example of an occlusion is a rectangle, such as rectangle 175 positioned over a portion of the screw head 130. This type of occlusion also uses the ground truth bounding box to localize the object and then selectively replaces a section of the object with a rectangle of pixels drawn from a particular color (although only a line drawing is shown in FIG. 1). As noted above, circular occlusions are also implemented, such as circular occlusion 195 positioned over knob 110. It should be appreciated that the circular occlusion approach is not, in at least one form, used with bounding boxes but with a grid of objects over the entire image. The grid can be circles, squares or lines or other figures.

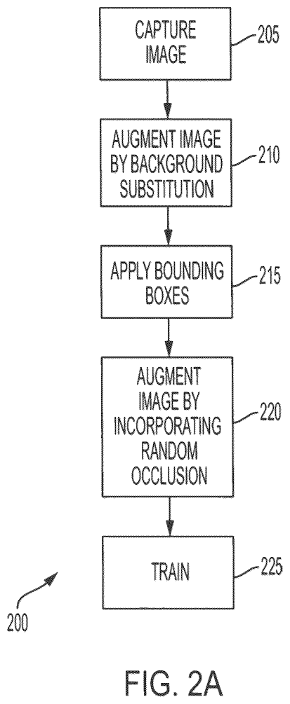

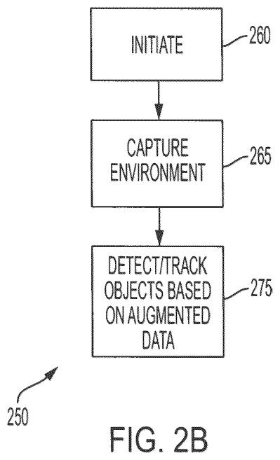

With reference to FIG. 2(a) and FIG. 2(b), example methods 200 and 250, respectively, according to the presently described embodiments are illustrated.

FIG. 2(a) illustrates a flowchart representing an example method 200 for generating a training set of data for a detecting and/or tracking system or network. As shown, an image of one object or more than one object is captured or loaded (at 205). It will be appreciated that, in at least one form of the presently described embodiments, images of specific objects or devices are captured against a uniform-colored background. In at least one form, the images are captured against a green background, although any color, form or texture of background could be used depending on the application.

The captured images are then augmented (at 210) by substituting a variety of natural and artificially generated backgrounds at various scales into the image. In this regard, in at least one form, a continuous chroma-key substitution using an angular hue filter and morphological operators is used to improve segmentation between background and foreground in the presence of shadows and other lighting anomalies. To improve robustness to occlusion, random object occlusions are introduced into images. In this regard, bounding boxes are first applied to the object(s) in the image (at 215). The random occlusions are then introduced (at 220). These occlusions could take a variety of forms in type and number. However, in at least one form of the presently described embodiments, the occlusions take three forms: 1) a generic grid of objects such as circles, squares or lines, 2) a random box relative to the bounding box that is intended to mimic object-object occlusion including hands and 3) a curtain augmentation that simulates occlusion due to edges intruding into the frame.

The data set generated by the presently described embodiments is then used to train an appropriate detecting or tracking system (at 225). It should be appreciated that the detecting or tracking system could take a variety of different forms. In one example form, the detecting or tracking system or network is based on the Yolo X convolutional neural network detection architecture together with a baseline MOSAIC augmentation in addition to the proposed augmentations described herein.

For comparison, and not for limitation, a standard Yolo X+MOSAIC model (a standard Yolo X detector (megvii implementation) with MOSAIC augmentation) and the results of the implementation of the presently described embodiments, e.g., a Yolo X+MOSAIC+chroma and occlusion augmentations, were tested on a sample dataset of objects taken against a different background. The precision of the two approaches was compared.

In this example and non-limiting situation, an equipment classifier trained on images taken against a single green-screen laboratory background but augmented with chroma key and the described occlusion technique, achieved an absolute 17 percentage point increase in precision over a baseline methods using the state-of-the-art MOSAIC augmentation technique developed in the context of Yolo V4.

In FIG. 2(b), a method 250 relating to an example implementation of the detecting or tracking system using the trained data set of, for example, FIG. 2(a) is shown. In this regard, the method is initiated by the system (at 260). It should be recognized that the system could take a variety of forms, including software integrated into a dedicated devise or a software application loaded on a computing device with video or image capture capabilities.

Once the system is triggered to initiate the method, the desired environment is captured by the system (at 265). In this regard, the system could be detecting or tracking objects for any number of purposes. Objects in view of the system are then detected by the system, based on the augmented image data set generated by the presently described embodiments (at 270).

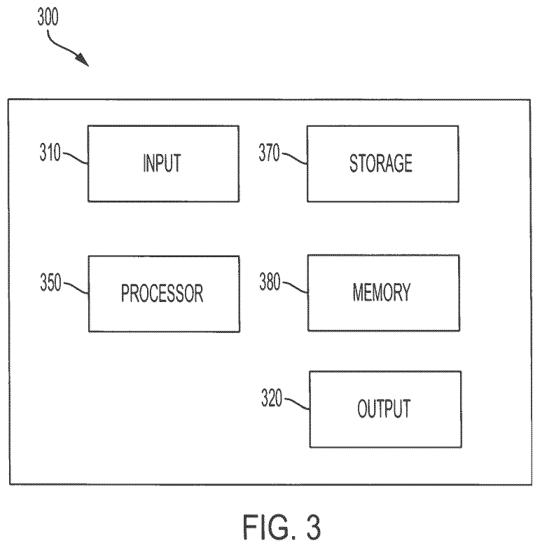

With reference now to FIG. 3, the above-described methods 200, 250 and other methods according to the presently described embodiments, as well as suitable architecture such as system components useful to implement the detecting or tracking systems contemplated herein and in connection with other embodiments described herein, can be implemented on a computer or computing device using well-known computer processors, memory units, storage devices, computer software, and other components. A high-level block diagram of such a computer is illustrated in FIG. 3. Computer 300 contains at least one processor 350, which controls the overall operation of the computer 300 by executing computer program instructions which define such operation. The computer program instructions may be stored in at least one storage device or memory 380 (e.g., a magnetic disk or any other suitable non-transitory computer readable medium or memory device) and loaded into another memory 380 (e.g., a magnetic disk or any other suitable non-transitory computer readable medium or memory device), or another segment of memory 370, when execution of the computer program instructions is desired. Thus, the steps of the methods described herein (such as method 200 of FIG. 2(a) or method 250 of FIG. 2(b)) may be defined by the computer program instructions stored in the memory 380 and controlled by the processor 350 executing the computer program instructions. The computer 300 may include one or more input elements 310 and output elements 320 for communicating with other devices via a network. The computer 300 also includes a user interface that enables user interaction with the computer 300. The user interface may include I/O devices (e.g., keyboard, mouse, speakers, buttons, etc.) to allow the user to interact with the computer. Such input/output devices may also include a camera or other vision-based elements to capture images or to frame an environment for a useful implementation in accordance with embodiments described herein. The user interface also includes a display for displaying images and spatial realism maps to the user.

According to various embodiments, FIG. 3 is a high-level representation of possible components of a computer for illustrative purposes and the computer may contain other components. Also, the computer 300 is illustrated as a single device or system. However, the computer 300 may be implemented as more than one device or system and, in some forms, may be a distributed system with components or functions suitably distributed in, for example, a network or in various locations.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to facilitate embodiments described above.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for creating data sets for robust object and action detectors from a small number of images gathered in one environment, the system comprising:
at least one processor; and
at least one memory having stored therein instructions, the memory and instructions being configured such that execution of the instructions by the processor causes the system to:
capture an image having at least one object therein, wherein the image has a background with at least one identifiable property;
augment the image by background substitution;
apply a bounding box around the object; and,
introduce random foreground occlusions to the object,
whereby augmented image data is obtained.

2. The system of claim 1 wherein the background substitution comprises continuous alpha blending between the image and the substitution based on an angular distance in hue space between the pixels in the background of the target image and the reference chroma value.

3. The system of claim 1 wherein the background substitution comprises random noise at multiple scales.

4. The system of claim 1 wherein the background substitution comprises natural images cropped, translated and resampled at multiple scales.

5. The system of claim 1 wherein the foreground occlusions comprise curtain occlusions that partially obscure left, right, top or bottom of objects to random degrees.

6. The system of claim 1 where the foreground occlusions comprise rectangles of various sizes sampled within a ground truth bounding box of the object in ground truth labels.

7. The system of claim 1 wherein the foreground occlusions comprise a grid of objects including at least one of circles, squares or lines.

8. The system as set forth in claim 1 wherein the memory and instructions are further configured such that execution of the instructions by the processor causes the system to train a detecting or tracking system based on the augmented image data.

9. A method for creating robust object and action detectors from a small number of images gathered in one environment, the method comprising;
capturing an image having at least one object therein, wherein the image has a background with at least one identifiable property;
augmenting the image by background substitution;
applying a bounding box around the object; and,
introducing random foreground occlusions to the object,
whereby augmented image data is obtained.

10. The method of claim 9 wherein the background substitution comprises continuous alpha blending between the image and the substitution based on an angular distance in hue space between the pixels in the background of the target image and the reference chroma value.

11. The method of claim 9 wherein the background substitution comprises random noise at multiple scales.

12. The method of claim 9 wherein the background substitution comprises natural images cropped, translated, and resampled at multiple scales.

13. The method of claim 9 wherein the foreground occlusions comprise curtain occlusions that partially obscure left, right, top or bottom of objects.

14. The method of claim 9 wherein the foreground occlusions comprise rectangles of various sizes sampled within ground truth bounding boxes of objects.

15. The method of claim 9 wherein the foreground occlusions comprise a grid of objects including at least one of circles, squares or lines.

16. The method as set forth in claim 9 further comprising training a detecting or tracking system based on the augmented image data.

17. A system for robust object and action detectors from a small number of images gathered in one environment, the system comprising:
at least one processor; and
at least one memory having stored therein instructions, the memory and instructions being configured such that execution of the instructions by the processor causes the system to:
capture the environment; and,
detect objects in the environment based using a model trained on data augmented by background substitution and foreground occlusions.

18. A method for robust object and action detectors from a small number of images gathered in one environment, the method comprising:
capturing the environment; and,
detecting objects in the environment based using a model trained on data augmented by background substitution and foreground occlusions.

19. A non-transitory computer readable medium having instructions stored thereon that, when executed, cause an apparatus to perform:
loading an image having at least one object therein, wherein the image has a background with at least one identifiable property;
augmenting the image by background substitution;
applying a bounding box around the object; and,
introducing random foreground occlusions to the object,
whereby augmented image training data is obtained, up to multiple times to augment the same image multiple times.

20. A non-transitory computer readable medium having instructions stored thereon that, when executed, cause an apparatus to perform:
capturing an environment; and,
detecting objects in the environment based on a model trained on data augmented by background substitution and foreground occlusions.
